(19) United States
(12) Patent Application Publication
(10) Pub. No.: US 2002/0148284 A1
(43) Pub. Date: Oct. 17, 2002

(54) Method and device for determining a concentration of fluidic fuels for use in fuel cells

(76) Inventors: Manfred Baldauf, Erlangen (DE); Waltraud Lager, Erlangen (DE); Walter Preidel, Erlangen (DE)

Correspondence Address: LERNER AND GREENBERG, P.A., Post Office Box 2480, Hollywood, FL, 33022-2480, US

(21) Appl. No.: 10/122,484

(22) Filed: Apr. 11, 2002

Related U.S. Application Data
(63) Continuation of application No. PCT/DE00/03570, filed on Oct. 10, 2000.

(30) Foreign Application Priority Data
Oct. 11, 1999 (DE) 199 48 908.4

(51) Int. Cl. G01N 25/00

(52) U.S. Cl. 73/61.46; 374/45

(57) ABSTRACT

The method determines the fuel concentration in fluidic fuels for fuel cells, and in particular the alcohol concentration in an alcohol/water mixture for fuel cells operated with the mixture, such as direct methanol fuel cells. The alcohol/water mixture is passed through a heating section at a constant flow rate, a known quantity of heat is supplied to the mixture, the temperature difference between the entry and exit of the heating section is measured and the alcohol concentration is determined therefrom.

### CROSS-REFERENCE TO RELATED APPLICATION

This application is a continuation of copending International Application No. PCT/DE00/03570, filed Oct. 10, 2000, which designated the United States.

### BACKGROUND OF THE INVENTION

1. Field of the Invention

The invention lies in the fuel cell technology field. More specifically, the invention relates to a method for determining the concentration of a fluidic fuel for a fuel cell, in particular the concentration of alcohol in an alcohol/water mixture for fuel cells operated with this mixture. The invention also relates to a device for carrying out the novel method. The invention is suitable for use with all fuel cells operated with fluidic fuels, and in particular for operation of a direct methanol fuel cell (DMFC).

To maintain the optimum operating parameters in fuel cells which are operated with fluid, in particular liquid fuels, it is necessary to control the fuel concentration. To do this, the current fuel concentration has to be determined.

Commonly assigned U.S. Pat. No. 5,624,538, and the corresponding European patent application EP 0 684 469 A1, describe a measuring unit for determining the concentration of low molecular weight alcohols, such as methanol, in water or acids. That measurement unit has a porous anode for the electrochemical oxidation of alcohol, a cathode for the electrochemical reduction of oxygen, an ion-conducting membrane arranged between anode and cathode, and a diffusion—limiting membrane, which is arranged on that side of the anode which is remote from the ion-conducting membrane. The measuring unit, which, so to speak, represents a fuel cell, is, for example, arranged in the fuel line and is kept at a defined cell voltage by potentiostatic means. Depending on the alcohol concentration, a current flows through the fuel cell, from the level of which current the concentration can be worked out by means of a calibration curve. A procedure of this nature is relatively complex, since current and voltage have to be measured or monitored.

In so-called direct methanol fuel cells (DMFCs), the fuel methanol undergoes direct electrochemical oxidation. That is, it is reacted without an intermediate reforming step. This is described in detail, for example, in the contribution by M. Waidhas to K. Ledjeff (Ed.) “Brennstoffzellen: Entwicklung, Technologie, Anwendung” [Fuel cells: development, technology, application], C. F. Müller Verlag GmbH, (Heidelberg 1995, pages 137-56). In order to reach the optimum operating point in particular in a DMFC, it is necessary to operate with excess dilute fuel, i.e. a methanol/water mixture.

For economic operation of a system composed of a plurality of direct methanol fuel cell units, which is referred to in the field simply as a “stack”, it is necessary for the excess fuel and the water, which functions not only as solvent but also as a reactant in accordance with the anode reaction

CH₃OH+H₂O→CO₂+6H⁺+6e⁻

to be circulated. This means that the methanol/water mixture, once it has left the stack and after the carbon dioxide formed during the oxidation of the methanol has been separated out, is fed back to the anode. Since a defined methanol concentration is required for operation of a DMFC stack, the methanol concentration in the anode circuit has to be continuously measured, and if the concentration is too low the missing quantity of fuel has to be metered in.

For on-line determination of the fuel concentration in the electrolyte of fuel cells, it has been proposed, as described in the commonly assigned, copending patent application No. 10/078,123 (German patent application 199 38 790.7), to determine the dielectric constant of the mixture, the level of which is dependent on the fuel concentration, by measuring the frequency-dependent capacitance of a measurement cell through which the fuel/electrolyte mixture flows. This requires accurate monitoring of pressure and temperature, and the measuring unit must operate with a very high level of accuracy. Moreover, this method of fuel determination is sensitive to carbon dioxide which is dissolved in the electrolyte and is always present, for example, in the anode circuit of a DMFC stack operated with liquid fuel.

### SUMMARY OF THE INVENTION

It is accordingly an object of the invention to provide a method and a device for determining a concentration of a fluidic fuel in a fuel cell, which overcomes the above-mentioned disadvantages of the heretofore-known devices and methods of this general type and which satisfies all the demands imposed on a determination method of this type. In this context, it is necessary, in particular, for it to be possible for the concentration determination to take place continuously and in parallel with the operation of the fuel cells or of the stack and for there to be no disruption caused by carbon dioxide which is present in the electrolyte.

With the foregoing and other objects in view there is provided, in accordance with the invention, a method of determining a fuel concentration of a fluidic fuel for a fuel cell, which comprises:

passing the fuel through a heating section at a constant flow rate;

supplying a given quantity of heat to the fuel; and

measuring a temperature difference in the fuel between a start and an end of the heating section, and determining therefrom the fuel concentration.

In accordance with an added feature of the invention, the fuel cell is operated with an alcohol/water mixture, and the method determines a concentration of alcohol in the alcohol/water mixture.

In accordance with an additional feature of the invention, the alcohol concentration is measured based on a dependency of the heat capacity of the alcohol/water mixture on the alcohol concentration.

In accordance with another feature of the invention, the fuel cell is a direct methanol fuel cell and the alcohol is a methanol, and the method comprises operating the fuel cell with a methanol/water mixture.

The invention in particular requires an alcohol/water mixture with a constant flow rate through a heating section. In the process, a known quantity of heat is supplied to the mixture, and the temperature difference between the start and end of the heating section is measured, from which measurement it is possible to quantitatively determine the alcohol concentration.

Especially in the latter methods, the fluid fuel used is an alcohol. The alcohol is in particular methanol, ethanol, propanol or glycol. Methanol is a suitable fuel for a direct methanol fuel cell (DMFC).

The method according to the invention makes use of the fact that the specific heat capacity of an alcohol/water mixture is greatly dependent on the composition of the mixture, i.e. the heat capacity changes with the alcohol content. For example—at 25° C.—the molar heat capacity at constant pressure Cp of water is 75.3 J/(mol.K). Data in this respect are compiled, for example, in CRC Handbook of Chemistry and Physics, 78th edition (1997), pages 5-4, 5-18 and 5-27.

In order, for determination of the alcohol concentration, for example in the anode circuit of direct methanol fuel cells, to utilize the change in the heat capacity of an alcohol/water mixture as a function of the concentration, in the method according to the invention a known quantity of heat Q is supplied to the anode liquid, and the resulting increase in temperature or temperature difference is recorded. The temperature difference ΔT is proportional to the specific heat capacity Cₚ of the measurement liquid, i.e. of the anode liquid, the specific heat capacity Cₚ being dependent on the composition of the alcohol/water mixture. The following relationships apply:

Q=CₚΔT (2)

Cₚ=Q/ΔT (2a).

The particular advantage of this measurement method consists in the fact that the quantity of heat supplied can be precisely monitored. The measurement variables used are the temperature difference ΔT and—if necessary—the flow rate dV/dt, which can be determined relatively accurately and without complex and expensive equipment. With the above and other objects in view there is also provided, in accordance with the invention, a device for determining a fuel concentration of a fluidic fuel for a fuel cell operated with the fuel and receiving the fuel through a feed line, the device comprising:

a measurement cell in the feed line for the fuel, the measurement cell having a heater element, and inlet, and an outlet;

a delivery pump for pumping the fuel; and

a measurement assembly for measuring a temperature difference between the inlet and the outlet of the measurement cell.

In accordance with a further feature of the invention, there is also provided a device for measuring a flow rate of the fuel.

In accordance with a preferred embodiment of the invention, the delivery pump is disposed upstream of the measurement cell in a flow direction of the fuel.

In accordance with again a further feature of the invention, there is provided a bypass line bypassing the feed line for the fuel. In that case, the measurement cell, the measurement assembly for measuring the temperature difference, and, if present, the device for measuring the flow rate, are disposed in the bypass line.

In accordance with again another feature of the invention, the measurement cell, the measurement assembly for measuring the temperature difference, and a pump are connected in the bypass line.

In accordance with a concomitant feature of the invention, the heater element is a flexible-tube heater or it is a heater coil.

In other words, a device for carrying out the method according to the invention has a measurement cell, which is arranged in a line for the alcohol/water mixture and has a heater element, a delivery pump for the mixture, which is arranged in this line, and means for measuring the temperature difference between the entry to and exit from the measurement cell, and also, if appropriate, the flow rate of the mixture. The delivery pump is preferably arranged upstream of the measurement cell, but may also be fitted into the line downstream of the measurement cell.

The measurement cell and the means for measuring the temperature difference and the flow rate are preferably arranged in a bypass to the line for the alcohol/water mixture. Alternatively, the measurement cell and the means for measuring the temperature difference, as well as a pump for the mixture, may be arranged in a bypass to the line for the alcohol/water mixture. With each alternative, the heater element is preferably a flexible-tube heater or a heater coil.

A device of this type has the advantage of being inexpensive to produce. Since it can be built in small and compact form, it can be miniaturized and is therefore suitable in particular for mobile applications, for example when using a fuel cell for a motor vehicle.

Further details and advantages of the invention will emerge from the description of exemplary embodiments, in particular with reference to experimental tests carried out on direct methanol fuel cells.

Although the invention is illustrated and described herein as embodied in a method and a device for determining the concentration of fluidic fuels for use in fuel cells, it is nevertheless not intended to be limited to the exemplary details described, since various modifications and structural changes may be made therein without departing from the spirit of the invention and within the scope and range of equivalents of the claims.

### DESCRIPTION OF THE PREFERRED EMBODIMENTS

In the tests for carrying out the method according to the invention, methanol/water mixtures of different concentrations were pumped at a constant flow rate, for example 100 ml/min, through a measurement cell, which was thermostated using a constant heating power. As soon as the methanol concentration was increased, for example from 0.5 mol/l to 1 mol/l, the temperature rose, specifically, in the case described, by approximately ΔT=2° C. The increase in temperature is reproducible, resulting in an accurately defined relationship in the tested range. Suitable temperature sensors can be used to measure the temperature to 1/10° C. and therefore to accurately determine the methanol concentration.

The measurement cell described is compact and can be used in a direct methanol fuel cell (DMFC) which is provided for mobile applications, for example in a motor vehicle, and wherein individual fuel cell units form a fuel cell stack.

Particularly in DMFC stacks, the invention can be implemented in such a manner that a calibration curve is compiled for a given measurement cell with a heater element—for a constant flow rate of the methanol/water mixture—by in each case supplying the same quantity of heat Q to various mixtures, in each case with a known methanol concentration, and then measuring the heating ΔT of the liquid between the entry to the cell and the exit from the cell. The concentration of a mixture of unknown concentration can be determined by calculation from this calibration curve after the temperature difference ΔT has been recorded for this mixture. If appropriate, calibration curves also have to be compiled for different flow rates. If there is a processor, for example a microcontroller, for operational control of the fuel cell assembly, these measures can be performed directly by this component.

There are two possibilities recommended for use of the device in a fuel cell assembly:

(a) The measurement cell with heater element is fitted directly into the anode circuit, and the alcohol/water mixture is pumped through the measurement cell by way of the circulation pump which is already present. The pump supplies the value dV/dt (≅flow rate). In that embodiment, however, the entire mixture has to be heated, which may entail a high outlay on energy or only a small increase in temperature.

(b) The measurement cell together with the heater element is installed in a bypass to the anode circuit. This has the advantage that only a small quantity of the alcohol/water mixture has to be heated. On account of this small quantity, which has a lower heat capacity, even relatively small quantities of heat produce temperature increases which can easily be measured. In this embodiment, however, it is necessary to ensure that a constant flow rate dV/dt prevails in the bypass, for example by using an additional pump.

I claim:

1. A method of determining a fuel concentration of a fluidic fuel for a fuel cell, which comprises:
passing the fuel through a heating section at a constant flow rate;
supplying a given quantity of heat to the fuel; and
measuring a temperature difference in the fuel between a start and an end of the heating section, and determining therefrom the fuel concentration.

2. The method according to claim 1, which comprises operating the fuel cell with an alcohol/water mixture, and determining a concentration of alcohol in the alcohol/water mixture.

3. The method according to claim 2, which comprises measuring the concentration of alcohol based on a dependency of a heat capacity of the alcohol/water mixture on the alcohol concentration.

4. The method according to claim 3, wherein the fuel cell is a direct methanol fuel cell and the alcohol is a methanol, and the method comprises operating the fuel cell with a methanol/water mixture.

5. A device for determining a fuel concentration of a fluidic fuel for a fuel cell operated with the fuel and receiving the fuel through a feed line, the device comprising:
a measurement cell in the feed line for the fuel, said measurement cell having a heater element, and inlet, and an outlet;
a delivery pump for pumping the fuel; and
a measurement assembly for measuring a temperature difference between the inlet and the outlet of said measurement cell.

6. The device according to claim 5, which comprises a device for measuring a flow rate of the fuel.

7. The device according to claim 5, wherein said delivery pump is disposed upstream of said measurement cell in a flow direction of the fuel.

8. The device according to claim 6, which comprises a bypass line bypassing the feed line for the fuel, wherein said measurement cell, said measurement assembly for measuring the temperature difference, and said device for measuring the flow rate are disposed in said bypass line.

9. The device according to claim 5, which comprises a bypass line bypassing the feed line for the fuel, wherein said measurement cell and said measurement assembly for measuring the temperature difference are disposed in said bypass line.

10. The device according to claim 5, which comprises a bypass line bypassing the feed line for the fuel, wherein said measurement cell, said measurement assembly for measuring the temperature difference, and a pump are connected in said bypass line.

11. The device according to claim 5, wherein said heater element is a flexible-tube heater.

12. The device according to claim 5, wherein said heater element is a heater coil.
